(19) United States
(12) Patent Application Publication
(10) Pub. No.: US 2025/0339248 A1
(43) Pub. Date: Nov. 6, 2025

(54) METHOD OF PRODUCING A DENTAL RESTORATION

(71) Applicant: Ivoclar Vivadent AG, Schaan (LI)

(72) Inventors: Mathias VETSCH, Grabs (CH); Atilim ESER, Rorschacherberg (CH)

(21) Appl. No.: 19/196,966

(22) Filed: May 2, 2025

(30) Foreign Application Priority Data
May 3, 2024 (EP) 24174056.2

(51) Int. Cl. A61C 13/00

(52) U.S. Cl. CPC A61C 13/0004; A61C 13/0006

(57) ABSTRACT

A method of producing a dental restoration, including the steps of providing (S101) a data set reproducing the spatial shape of the dental restoration; selecting (S102) a tool for producing the dental restoration having a predetermined tool radius; and adjusting (S103) the data set so that a radius of curvature on the surface of the reproduced spatial shape is greater than or equal to the tool radius.

### CROSS-REFERENCE TO RELATED APPLICATIONS

This application claims priority to European Patent Application No. 24174056.2 filed on May 3, 2024, the disclosure of which is incorporated herein by reference in its entirety.

### TECHNICAL FIELD

The present invention relates to a method of producing a dental restoration, a computer program for executing the method and a production apparatus with a computer program.

WO 02/076327 and WO 2023/202143 are directed to methods and systems for the design of dental restorations and are hereby incorporated by reference.

### SUMMARY

It is the technical task of the present invention to improve the production of a dental restoration.

This task is solved by subject-matter according to the independent claims. Advantageous embodiments are the subject-matter of the dependent claims, the description and the figures.

According to a first aspect, the present task is solved by a method of producing a dental restoration, comprising the steps of providing a data set reproducing the spatial shape of the dental restoration; selecting a tool for producing the dental restoration which has a predetermined tool radius; and adjusting the data set so that a radius of curvature on the surface of the reproduced spatial shape is greater than or equal to the tool radius. The method achieves the technical advantage that the dental restoration can be produced with greater accuracy.

In a technically advantageous embodiment of the method, the data set is adjusted so that all points on the surface of the reproduced spatial shape are touchable by the tool. This achieves the technical advantage, for example, that the dental restoration can be produced completely with the selected tool.

In another technically advantageous embodiment of the method, the spatial shape of the dental restoration is reproduced by a surface grid. This achieves the technical advantage, for example, that the spatial shape of the dental restoration can be reproduced with a high degree of accuracy and with relatively little data.

In another technically advantageous embodiment of the method, the surface grid is converted into a discrete Cartesian grid. This achieves the technical advantage, for example, that the data set can be easily adjusted to the tool radius.

In another technically advantageous embodiment of the method, the radius of curvature on the surface of the reproduced spatial shape is calculated based on the discrete Cartesian grid. This also achieves the technical advantage, for example, that the data set can be easily adjusted to the tool radius.

In another technically advantageous embodiment of the method, the discrete Cartesian grid is adjusted such that a radius of curvature on the surface of the reproduced spatial shape is greater than or equal to the tool radius. This achieves the technical advantage, for example, that the dental restoration can be produced with the selected tool.

In another technically advantageous embodiment of the method, the vertices of the surface grid are shifted in the direction of the adjusted discrete Cartesian grid. This achieves the technical advantage, for example, that the adjustment of the data set to the tool radius can be carried out in a simple manner.

In another technically advantageous embodiment of the method, an error function is optimized which is based on a distance between the respective vertices of the surface grid and the points of the discrete Cartesian grid and/or based on Laplace smoothing. This achieves the technical advantage, for example, that a smooth spatial shape of the dental restoration without edges can be produced.

In another technically advantageous embodiment of the method, the surface of the reproduced spatial shape is divided into a first sub-region which can be touched by the tool and a second sub-region which cannot be touched by the tool. This achieves the technical advantage, for example, that an optimization can be applied exclusively to the respective sub-region and a calculation time is reduced.

In another technically advantageous embodiment of the method, a production material of the dental restoration is selected based on the radius of curvature on the surface of the reproduced spatial shape. This achieves the technical advantage, for example, that the dental restoration can be produced more realistically with higher radii of curvature.

In another technically advantageous embodiment of the method, the tool is selected based on the radius of curvature on the surface of the reproduced spatial shape. This achieves the technical advantage, for example, that a suitable tool for producing the dental restoration is obtained.

In another technically advantageous embodiment of the method, the tool is a milling tool or a drill. This achieves the technical advantage, for example, that the dental restoration can be produced efficiently.

In another technically advantageous embodiment of the method, the dental restoration is produced based on the data set. This achieves the technical advantage, for example, that a dental restoration is produced with a high degree of spatial accuracy.

According to a second aspect, the present task is solved by a computer program comprising instructions which, when the computer program is executed by a computer, cause the computer to execute the method according to the first aspect. This achieves the same technical advantages as the method according to the first aspect. The computer program product may include program code which is stored on a non-transitory machine-readable medium, the machine-readable medium including computer instructions executable by a processor, which computer instructions cause the processor to perform the method herein.

According to a third aspect, the present task is solved by a production apparatus for producing a dental restoration with a computer program according to the second aspect. This achieves the same technical advantages as the method according to the first aspect.

### BRIEF DESCRIPTION OF THE DRAWINGS

Exemplary embodiments of the invention are shown in the drawings and are described in more detail below, in which:

FIG. 1 shows a view of a dental restoration;

FIG. 2 shows a view of a voxelized dental restoration;

FIG. 3 shows a view of a dental restoration for a tool with three different tool radii;

FIG. 4 shows views of dental restorations with different radii of curvature;

FIG. 5 shows views of dental restorations made of different production materials; and

FIG. 6 shows a block diagram of a method of producing a dental restoration.

### DETAILED DESCRIPTION

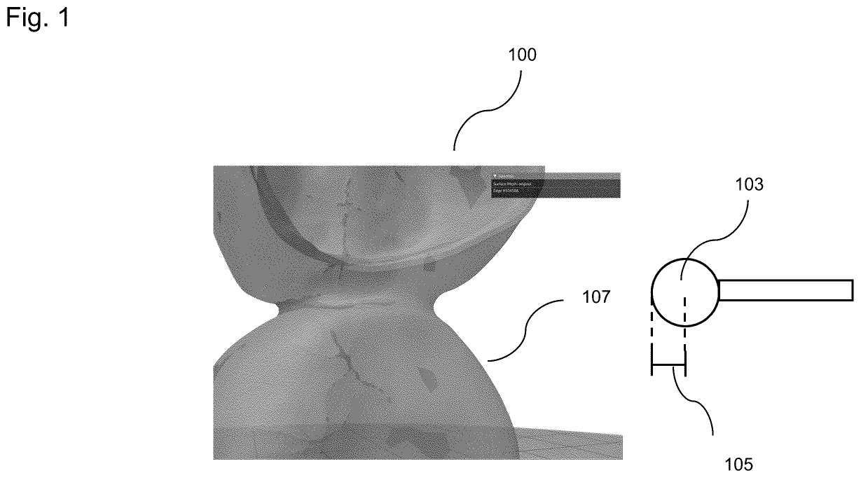

FIG. 1 shows a view of a dental restoration 100 with a predetermined spatial shape 107. The dental restoration is, for example, a bridge, a crown, an inlay or an onlay. The dental restoration 100 is designed using a computer, for example using CAD software. Here, the dental restoration 100 is reproduced by a digital data set that reproduces the spatial shape 107 of the dental restoration 100 and other properties, such as the production material.

For this purpose, the data set comprises the spatial coordinates of grid points (vertices) on the surface of the dental restoration 100, which are connected to each other by a set of grid lines. This creates an overlap-free surface grid of the space of the dental restoration 100 through a set of grid cells. The spatial shape 107 of the dental restoration 100 is reproduced by this surface grid.

This original data set can be used to calculate the physical geometry of the dental restoration 100, which can be produced using a selected tool 103. For this purpose, certain curvature conditions are applied to the surface of the dental restoration 100. In this process, the original spatial shape 107 of the dental restoration 100 is changed in such a way that all points on the surface of the dental restoration 100 can be reached or touched by the tool 103 with a predetermined tool radius 105.

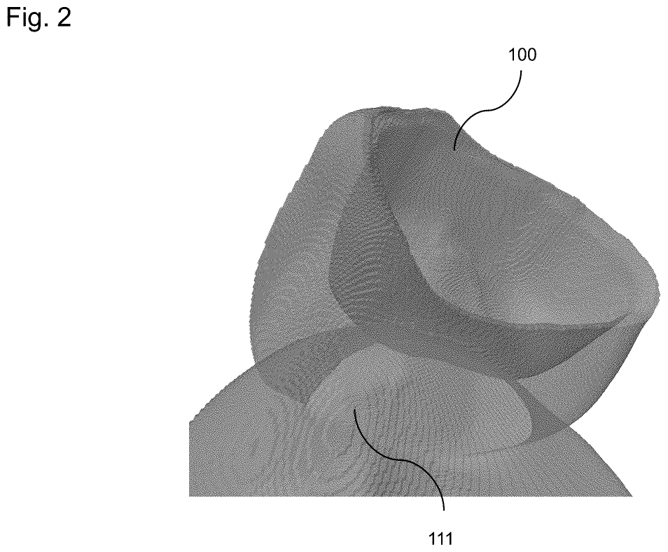

FIG. 2 shows a view of a voxelized, discrete dental restoration 100. During voxelization, the volume of the original spatial shape 107 of the dental restoration 100 is filled by means of discrete cuboid voxels. After voxelization, the spatial shape 107 of the dental restoration 100 is not indicated by a spatial surface grid, but by a discrete filling of the occupied space by individual voxels. These voxels are arranged in a Cartesian grid 111.

By voxelizing the spatial shape 107, the calculation results can be simplified and improved when calculating the curvature of the surface. Compared to a calculation based on the surface grid, discretization artefacts can be avoided.

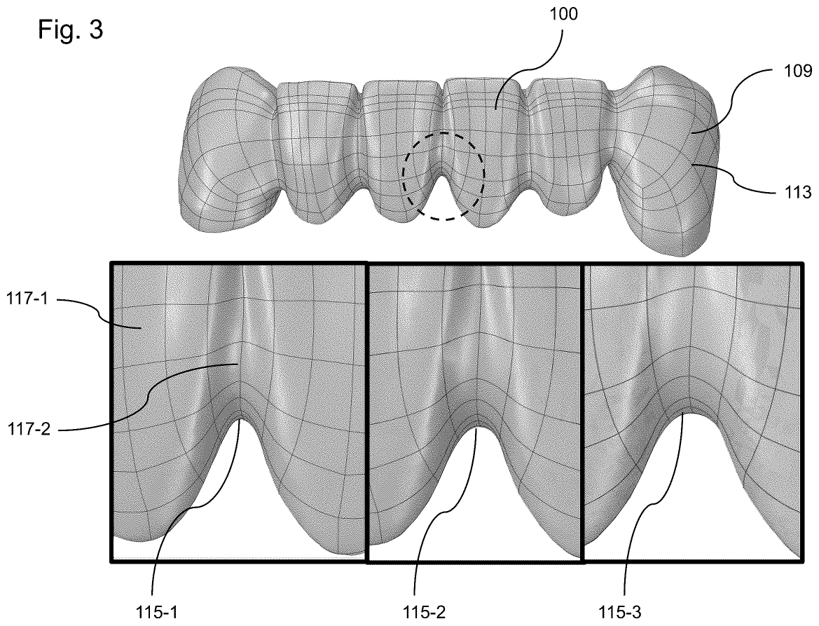

FIG. 3 shows a view of the dental restoration 100 with three different radii of curvature 115-1 to 115-3 in the transition region between two teeth. The originally designed spatial shape 107 of the dental restoration 100 has, for example, the radius of curvature 115-1 in the transition region of the surface grid 109 between the teeth.

If a tool 103 with a larger tool radius 105 is to be used, the spatial shape 107 of the dental restoration 100 is adjusted in the transition region by the method so that the radius of curvature 115-2 between the teeth is greater than or equal to the tool radius 105. If a tool 103 with an even larger tool radius 105 is used, this results in an even larger radius of curvature 115-3 in the transition region. This ensures that all points of the surface can be touched by the tool 103 in the transition region and that the dental restoration 100 can be produced.

First, the surface of the spatial shape 107 is divided into two types of sub-regions 117-1 and 117-2. The first type of sub-region 117-1 is accessible by the tool 103, since it has a radius of curvature 115-1 that is larger than the tool radius 105.

The second type of sub-region 117-2 is not accessible by the tool 103 because it has a radius of curvature 115-2 that is smaller than the tool radius 105. In the sub-region 117-2, the vertices 113 of the surface grid 109 are displaced in the direction of the voxelized, discrete dental restoration 100. By distinguishing the sub-regions 117-1 and 117-2, it is possible to carry out the process precisely, so that computing time can be saved.

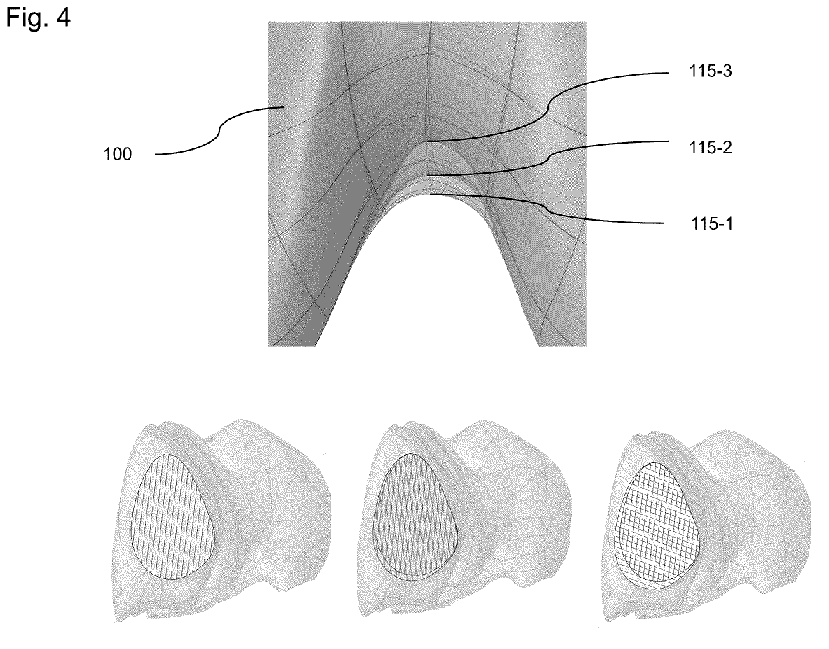

FIG. 4 also shows views of dental restorations 100 with different radii of curvature 115-1 to 115-3. Adjustment of the data set is achieved by optimizing an error function comprising a distance to the voxelized, discrete shape 107 of the dental restoration 100 and a Laplacian smoothing target function smoothing target. A gradient method can be used iteratively to optimize the surface. This can be supported by an iterative change of the topology, in which the longest edges are flipped (flip longest edges).

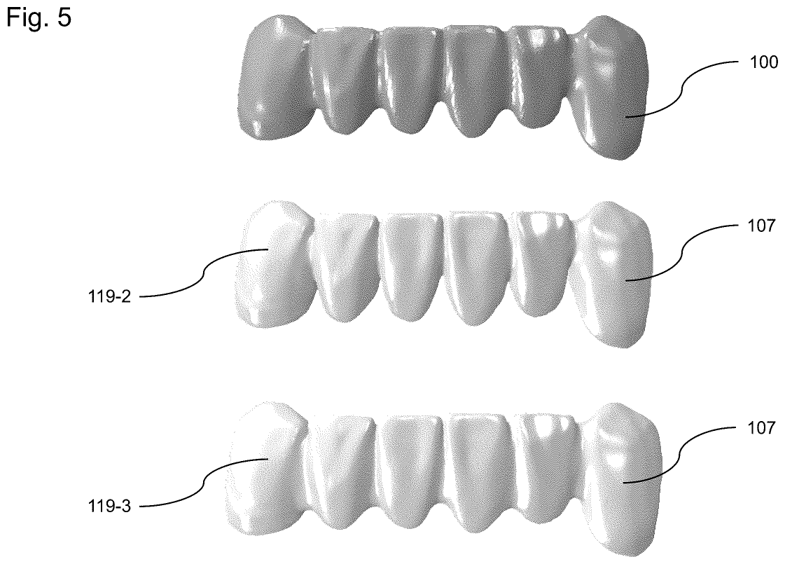

FIG. 5 shows views of dental restorations 100 made of different production materials 119-2 and 119-3. The production material 119 of the dental restoration 100 can also be calculated, for example, on the basis of the radius of curvature 115 on the surface of the reproduced spatial shape 107.

If the adjusted spatial shape 107 has a smaller radius of curvature than the original shape 107, a production material 119-2 with a higher strength is used. If, on the other hand, the adjusted spatial shape 107 has a larger radius of curvature than the original shape 107, a production material 119-3 with a lower strength is used.

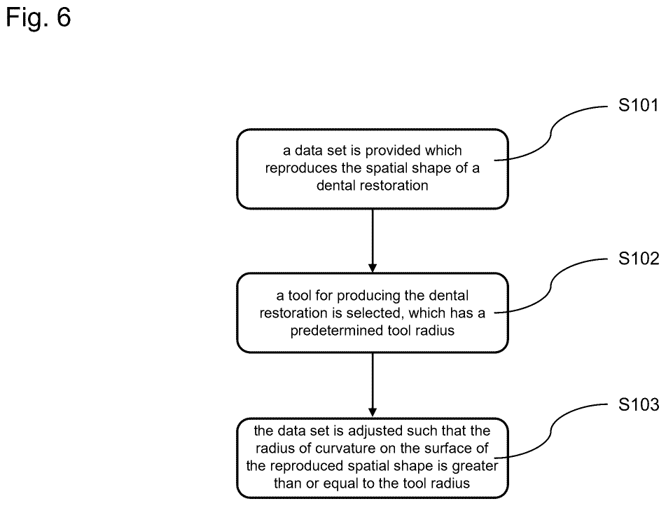

FIG. 6 shows a block diagram of a method of producing the dental restoration 100. In step S101, the data set is provided which reproduces the spatial shape 107 of the dental restoration 100. In step S102, the tool 103 for producing the dental restoration 100 is selected, which has a predetermined tool radius 105. In step S103, the data set is adjusted such that the radius of curvature 115 on the surface of the reproduced spatial shape 107 is greater than or equal to the tool radius 105.

The spatial shape 107 of the dental restoration 100 adjusted in this way can then be produced from a dental blank by means of a milling process in which a corresponding milling tool or a drill is used.

According to the method, the spatial shape 107 of the dental restoration 100 can be changed by adding or removing production material. When selecting a tool 103 with a larger tool radius 105, production material 119 is added. On the other hand, when selecting a tool 103 with a smaller tool radius 105, production material is removed.

The method can be carried out by a computer program on a computer that implements the individual steps. The method can ensure that the dental restoration 100 can be produced precisely with the selected tool 103.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 dental restoration
103 tool
105 tool radius
107 spatial shape
109 surface grid
111 Cartesian grid
113 vertex
115 radius of curvature
117 sub-region
119 production material

1. A method of producing a dental restoration, comprising the steps of:
providing a data set reproducing the spatial shape of the dental restoration;
selecting a tool for producing the dental restoration which has a predetermined tool radius; and
adjusting the data set so that a radius of curvature on the surface of the reproduced spatial shape is greater than or equal to the tool radius.

2. The method according to claim 1, wherein the data set is adjusted such that all points on the surface of the reproduced spatial shape are touchable by the tool.

3. The method according to claim 1, wherein the spatial shape of the dental restoration is reproduced by a surface grid.

4. The method according to claim 3, wherein the surface grid is converted into a discrete Cartesian grid.

5. The method according to claim 4, wherein the radius of curvature on the surface of the reproduced spatial shape is calculated based on the discrete Cartesian grid.

6. The method according to claim 5, wherein the discrete Cartesian grid is adjusted such that a radius of curvature on the surface of the reproduced spatial shape is greater than or equal to the tool radius.

7. The method according to claim 6, wherein vertices of the surface grid are shifted in the direction of the adjusted discrete Cartesian grid.

8. The method according to claim 7, wherein an error function is optimized which is based on a distance between the respective vertices of the surface grid and the points of the discrete Cartesian grid and/or based on Laplace smoothing.

9. The method according to claim 1, wherein the surface of the reproduced spatial shape is divided into a first sub-region which can be touched by the tool and a second sub-region which cannot be touched by the tool.

10. The method according to claim 1, wherein a production material of the dental restoration is selected based on the radius of curvature on the surface of the reproduced spatial shape.

11. The method according to claim 1, wherein the tool is selected based on the radius of curvature on the surface of the reproduced spatial shape.

12. The method according to claim 1, wherein the tool is a milling tool or a drill.

13. The method according to claim 1, wherein the dental restoration is produced based on the data set.

14. A computer program product comprising program code which is stored on a non-transitory machine-readable medium, the machine-readable medium comprising computer instructions executable by a processor, which computer instructions cause the processor to perform the method according to claim 1.

15. A production apparatus for producing a dental restoration with the computer program according to claim 14.
